(19) United States
(12) Patent Application Publication
(10) Pub. No.: US 2026/0016302 A1
(43) Pub. Date: Jan. 15, 2026

(54) VALIDATING A SLAM SYSTEM OUTPUT

(71) Applicant: TOYOTA JIDOSHA KABUSHIKI KAISHA, TOYOTA-SHI (JP)

(72) Inventors: PAUL J. OZOG, Ann Arbor, MI (US); MOHAMED ALADEM, Ypsilanti, MI (US); MATTHEW DREISBACH, Ann Arbor, MI (US)

(21) Appl. No.: 18/769,188

(22) Filed: Jul. 10, 2024

(51) Int. Cl. G01C 21/30

(52) U.S. Cl. CPC G01C 21/30

(57) ABSTRACT

Systems and methods for validating accuracy of a Simultaneous Localization and Mapping (SLAM) representation are provided. For example, a methodology of the presently disclosed technology may comprise: (1) generating a Simultaneous Localization and Mapping (SLAM) representation of an environment; (2) using a machine learning model to quantify accuracy of the SLAM representation based on values for pre-selected features of the SLAM representation; and (3) generate a digital representation for the quantified accuracy of the SLAM representation. In certain embodiments, the pre-selected features of the SLAM representation may comprise at least one of: (a) distance between landmarks in the SLAM representation; or (b) node degrees for the landmarks in the SLAM representation.

### TECHNICAL FIELD

The present disclosure relates generally to automotive systems and technologies. More particularly, some embodiments relate to validating accuracy for a Simultaneous Localization and Mapping (SLAM) representation.

### DESCRIPTION OF RELATED ART

Vehicle sensors (e.g., imaging and proximity sensors, gyroscopes, odometers, etc.) can collect information about a vehicle and the vehicle's surroundings. Such data can be used to generate a digital representation (e.g., a geometric map) of an environment surrounding the vehicle. For example, a system may mount an imaging sensor (e.g., a camera) to a vehicle in motion within an environment. The system can use image data generated by the imaging sensor to generate a digital representation of the environment.

Simultaneous Localization and Mapping (“SLAM”) is one technique for generating such a digital representation. A SLAM system can generate a digital representation of an environment (sometimes referred to herein as a SLAM representation) while simultaneously tracking location of a vehicle within that environment.

Vehicle trace data is a type of data utilized by SLAM systems (and other similar systems) to generate a digital representation of an environment. As used herein, vehicle trace data may refer to any combination of: (1) data related to a three-dimensional (3D) trajectory of a vehicle (e.g., vehicle location, vehicle pose, etc.) as the vehicle traverses an environment; and (2) data related to landmarks (e.g., lane markers, road boundaries, road signs, etc.) observed by vehicle sensors as the vehicle traverses the environment.

### BRIEF SUMMARY OF THE DISCLOSURE

According to various embodiments of the disclosed technology, a system is provided. The system, in accordance with embodiments of the technology disclosed herein comprises: (1) one or more processing resources; and (2) non-transitory computer-readable medium, coupled to the one or more processing resources, comprising stored instructions that when executed by the one or more processing resources, cause the system to: (a) generate a Simultaneous Localization and Mapping (SLAM) representation of an environment; (b) use a machine learning model to quantify accuracy of the SLAM representation based on values for pre-selected features of the SLAM representation; and (c) generate a digital representation for the quantified accuracy of the SLAM representation.

In certain embodiments, the pre-selected features of the SLAM representation may comprise at least one of: (i) distance between two or more landmarks in the SLAM representation; or (ii) node degrees for landmarks in the SLAM representation. In some of such embodiments, a node degree for a respective landmark in the SLAM representation may correspond to a number of observations from different viewpoints the SLAM representation correlates with the respective landmark.

In certain embodiments, the SLAM representation may comprise a geometric map.

In various embodiments, the digital representation for the quantified accuracy of the SLAM representation may comprise a heat map superimposed on the SLAM representation.

In some embodiments, the machine learning model may comprise a random forest model.

In certain embodiments, the machine learning model may use a five-fold cross-validation method to quantify accuracy for individual regions of the SLAM representation.

In various embodiments, the non-transitory computer-readable medium may comprise further stored instructions, that when executed by the one or more processing resources, cause the system to provide, via a graphical user interface (GUI), the digital representation for the quantified accuracy of the SLAM representation.

In some embodiments, the non-transitory computer-readable medium may comprise further stored instructions, that when executed by the one or more processing resources, cause the system to: (a) receive vehicle trace data from connected vehicles traversing the environment; and (b) apply a SLAM algorithm to the vehicle trace data to generate the SLAM representation.

In certain embodiments, the vehicle trace data may comprises at least one of: (i) data related to three-dimensional (3D) trajectories of the connected vehicles as the connected vehicles traverse the environment; or (ii) data related to landmarks observed by sensors of the connected vehicles as the connected vehicles traverse the environment.

In various embodiments, a method is provided. The method, in accordance with embodiments of the technology disclosed herein comprises: (1) receiving vehicle trace data from connected vehicles traversing an environment; (2) using a machine learning model to quantify accuracy of the SLAM representation based on values for pre-selected features of the SLAM representation; (3) generating a digital representation for the quantified accuracy of the SLAM representation; and (4) providing, via a graphical user interface (GUI) of a user device, the digital representation for the quantified accuracy of the SLAM representation.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIGS. 1A-1B illustrate an example architecture for validating SLAM representation accuracy, in accordance with various embodiments of the presently disclosed technology.

FIG. 2 illustrates a comparison between digital representations of an environment before and after SLAM optimization, in accordance with various embodiments of the presently disclosed technology.

FIG. 3 illustrates an example digital representation quantifying accuracy for a SLAM representation, in accordance with various embodiments of the presently disclosed technology.

FIG. 4 illustrates an example process that can be performed to validate SLAM representation accuracy, in accordance with various embodiments of the presently disclosed technology.

FIG. 5 illustrates an example process that can be performed to train a machine learning model to validate SLAM representation accuracy, in accordance with various embodiments of the presently disclosed technology.

FIG. 6 is an example computing component that may be used to implement various features of embodiments described in the present disclosure.

The figures are not exhaustive and do not limit the present disclosure to the precise form disclosed.

### DETAILED DESCRIPTION

As described above, a SLAM system can generate a digital representation of an environment (sometimes referred to herein as a SLAM representation) while simultaneously tracking location of a vehicle within that environment.

In certain cases, a SLAM representation may include defective areas where the SLAM representation does not accurately map an environment. Such inaccuracies can cause safety and other issues for a vehicle that relies on the SLAM representation for navigation and other tasks (e.g., autonomous driving). Accordingly, there is an important need for systems/methods that reliably validate accuracy for SLAM representations.

However, validating SLAM representation accuracy-particularly for SLAM representations mapping large geographic areas-can be a serious challenge. For example, a conventional technique for validating SLAM representation accuracy may involve comparing a SLAM representation to “ground-truth” trajectories of vehicles that provide input data (e.g., vehicle trace data) used to generate the SLAM representation. However, typical sensors used to obtain “ground truth” vehicle trajectories—such as real time kinematics (RTK) sensors—can be extremely expensive. For this reason, such sensors are rarely included in consumer vehicles. Thus, SLAM systems that rely on input data from consumer vehicles—which can be a common approach for generating SLAM representations of large geographic areas—are generally unable to utilize comparisons to “ground truth” vehicle trajectories to validate SLAM representation accuracy. Another conventional technique may involve predicting accuracy for a prospective SLAM representation using the raw sensor data a SLAM system uses to generate SLAM representations. However, such raw sensor data is not always available/accessible for a validation system. Relatedly, even if such raw sensor data is available, it can be very large and thus take a large amount of time and resources for a validation system to process. Moreover the validation technique may be tied to the type of raw sensor data (e.g., visual data obtained from camera) being used to generate the SLAM representations. Thus, the validation technique may be less effective for predicting SLAM representation accuracy where other types of sensor data are used.

Against this backdrop, aspects of the presently disclosed technology may be implemented to validate accuracy of a SLAM representation in the absence of “ground truth” vehicle trajectory data. Namely, a system of the presently disclosed technology may utilize a machine learning model to quantify accuracy of a SLAM representation based on values for intelligently curated features of the SLAM representation. The system may then generate a digital representation for the quantified accuracy of the SLAM representation. In various embodiments, the digital representation may comprise a heat map superimposed on the SLAM representation. In certain embodiments, the system may provide the digital representation via a graphical user interface (GUI).

By training a machine learning model to quantify accuracy of a SLAM representation based on values for intelligently curated features of the SLAM representation, the system can validate accuracy of a SLAM representation in the absence of “ground truth” vehicle trajectory data. Here, the intelligently curated features of the SLAM representation may be important, indirect indicators of SLAM representation accuracy.

Distance between landmarks in a SLAM representation is one example SLAM representation feature that the system can use to quantify/predict SLAM representation accuracy. As the system is designed in appreciation of, accuracy/crispness of a SLAM representation may increase when a relatively higher proportion of the input data used to generate the SLAM representation comprises perceptual data vs. proprioception data. Distance between landmarks in the SLAM representation can indirectly measure this proportion between perceptual data vs. proprioception data. Namely, the farther a vehicle has to travel between perceiving two landmarks, the more the vehicle will rely on proprioception (e.g., dead-reckoning) techniques to infer its location/trajectory. In other words, the farther the vehicle has to travel between perceiving two landmarks, the less the vehicle can rely on perceptual techniques to infer its location/trajectory. In this way, distance between landmarks in the SLAM representation can indirectly measure the proportion between perceptual data vs. proprioception data in the input data used to generate the SLAM representation. For these reasons, training a machine learning model to quantify accuracy for SLAM representations based in part on distances between landmarks in the SLAM representations, can provide an improved methodology for validating SLAM representation accuracy.

Node degree for landmarks in a SLAM representation is another example SLAM representation feature that the system can use to quantify/predict SLAM representation accuracy. As used herein, a node degree for a respective landmark may correspond to a number of observations from different viewpoints a SLAM representation correlates with the respective landmark. As the system is designed in appreciation of, node degree can be a useful (indirect) measure of data association confidence for the SLAM representation. Namely, increasing node degree can correlate with increasing data association confidence for the SLAM representation. Relatedly, increasing data association confidence for landmarks in the SLAM representation may correlate with increasing accuracy for the SLAM representation. For these reasons, training a machine learning model to quantify accuracy for SLAM representations based in part on node degree for landmarks in the SLAM representations, can provide an improved methodology for validating SLAM representation accuracy.

In addition to (or in lieu of) distance between landmarks and node degree, the system may utilize other intelligently curated features of a SLAM representation to quantify accuracy for the SLAM representation. For example, the system may train a machine learning model to quantify accuracy for a SLAM representation based on hundreds of SLAM representation features or more.

By reliably validating accuracy for SLAM representations, the system can provide numerous technical/practical advantages. For example, automatic and reliable validation of SLAM representations can reduce costs (e.g., costs of human efforts required to QA maps) for validating maps/representations eventually deployed in vehicles for navigation and autonomous driving tasks. Relatedly, reliable automated validation can identify regions which would benefit from additional human validation, or regions which would benefit from further (or higher resolution) data collection. In still further implementations, an autonomous driving system may be triggered to hand over control to a human driver when a vehicle enters a region where SLAM representation accuracy has been identified (by the presently disclosed system) as poor.

Moreover, the system may provide certain technical advantages over potential alternative solutions. For example, the system does not rely on ground-truth trajectories to validate a SLAM representation (instead, and as described above, the system analyzes intelligently curated features of the SLAM representation to validate SLAM representation accuracy). Accordingly, the system may be better-suited for SLAM systems which rely on input data from consumer vehicles that often lack the specialized sensors (e.g., RTK sensors) required to generate ground-truth trajectories. Relatedly, the system does not rely on raw sensor data to predict/validate accuracy for SLAM representations. Accordingly, the system may be better-suited for implementations which do not have easy access to such raw sensor data. Relatedly, the system may perform faster validations and require fewer memory/processing resources than potential alternatives which use (often massive volumes of) raw sensor data to predict/validate accuracy for SLAM representations. Accordingly, the system may be more scalable for larger geographic areas than these potential alternatives.

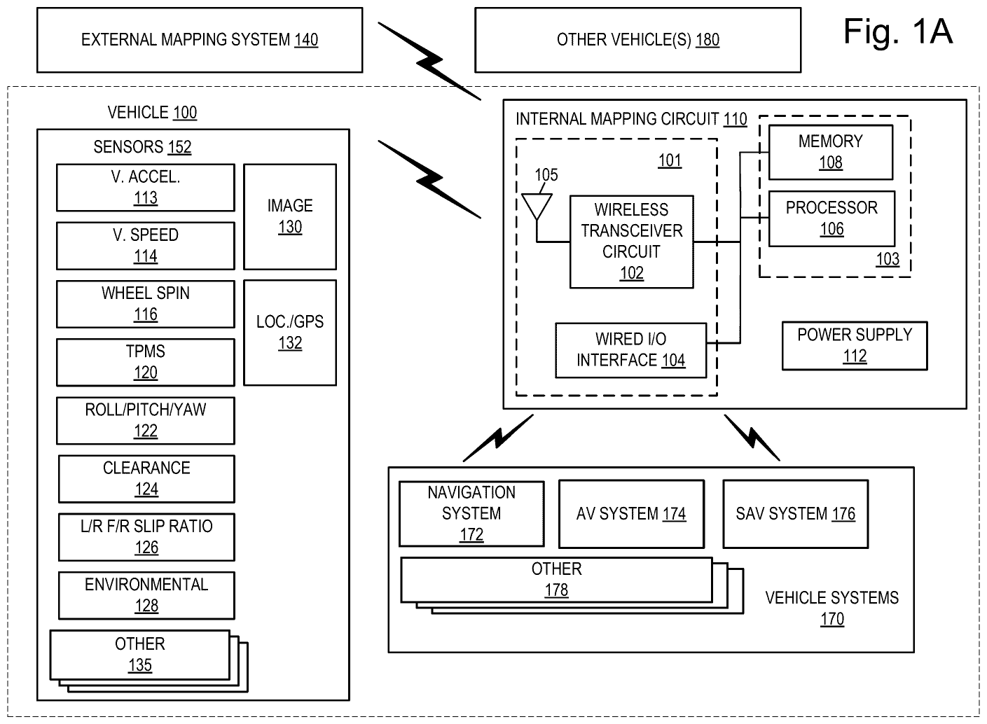

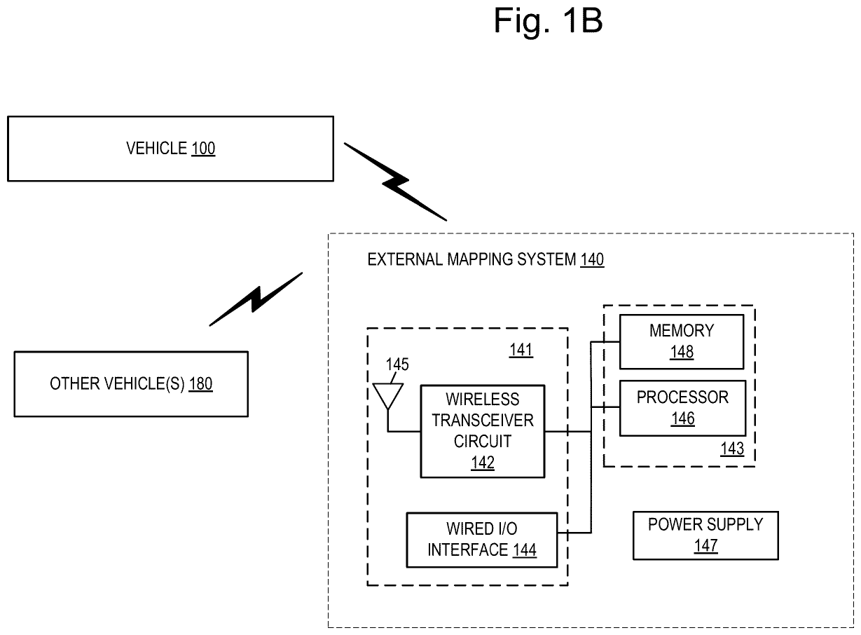

The systems and methods disclosed herein may be implemented with any of a number of different vehicles and vehicle types. For example, the systems and methods disclosed herein may be used with automobiles, trucks, motorcycles, recreational vehicles and other types of vehicles. In addition, the principles disclosed herein may be utilized by systems that are external from vehicles (e.g., external mapping system 140 of FIGS. 1A-1B).

FIGS. 1A-1B illustrate an example architecture for validating SLAM representation accuracy, in accordance with various embodiments of the presently disclosed technology.

As depicted, the example architecture includes a vehicle 100 (depicted in greater detail in FIG. 1A), an external mapping system 140 (depicted in greater detail in FIG. 1B), and other vehicle(s) 180. Vehicle 100, external mapping system 140, and other vehicle(s) 180 can communicate with each other via wireless communication.

Before describing individual components of vehicle 100 and external mapping system 140 in more detail, a high level operational overview may be useful.

In certain embodiments, external mapping system 140 can obtain vehicle trace data from vehicle 100 and other vehicle(s) 180. Other vehicle(s) 180 may include any number of vehicle (e.g., on the order of hundreds or thousands of vehicles). As described above, the vehicle trace data may comprise any combination of: (1) data related to three-dimensional (3D) trajectories of vehicle 100 and other vehicle(s) 180 as the vehicles traverse an environment; and (2) data related to landmarks (e.g., lane markers, road boundaries, road signs, traffic lights, and other landmarks/features of the environment) observed by sensors of vehicle 100 and other vehicle(s) 180 as the vehicles traverse the environment.

External mapping system 140 can utilize such vehicle trace data to generate a digital representation of the environment. In some embodiments, external mapping system 140 can also utilize such vehicle trace data to simultaneously localize vehicle 100 and other vehicle(s) 180. In certain of these embodiments, external mapping system 140 may utilize Simultaneous Localization and Mapping (“SLAM”) techniques for this purpose. For example, external mapping system 140 can utilize vehicle trace data from vehicle 100 and other vehicle(s) 180 to generate a SLAM representation (e.g., a geometric map) of an environment.

As described above (and as described in greater detail below), external mapping system 140 can utilize (and train) a machine learning model to quantify accuracy of the SLAM representation based on values for intelligently curated features of the SLAM representation. External mapping system 140 may then generate a digital representation for the quantified accuracy of the SLAM representation. In various embodiments, the digital representation may comprise a heat map superimposed on the SLAM representation. In certain embodiments, external mapping system 140 may provide the digital representation via a graphical user interface (GUI).

As described above, external mapping system 140 can quantify accuracy of the SLAM representation without relying on “ground truth” trajectory data of vehicle 100 and other vehicle(s) 180. While conventional techniques could compare “ground truth” vehicle trajectories to a SLAM representation to validate accuracy for the SLAM representation, typical sensors used to measure “ground truth” vehicle trajectory (e.g., RTK sensors) can be extremely expensive. For this reason, such sensors are rarely included in consumer vehicles. Thus, SLAM systems (e.g., external mapping system 140) which rely on input data from consumer vehicles—which can be a common approach for generating SLAM representations of large geographic areas—are generally unable to utilize comparisons to “ground truth” vehicle trajectories to validate accuracy for a SLAM representation. Accordingly, by quantifying SLAM representation accuracy without relying on “ground truth” vehicle trajectory data, external mapping system 140 may provide a technical improvement over conventional techniques/systems that rely on such data.

Like external mapping system 140, internal mapping circuit 110 of vehicle 100 can also utilize vehicle trace data to generate a digital representation of the environment surrounding vehicle 100 (such vehicle trace data may be obtained from any combination of sensors 152 of vehicle 100, external mapping system 140, and other vehicle(s) 180). In some embodiments, internal mapping circuit 110 can also utilize such vehicle trace data to localize vehicle 100 simultaneously. In certain of these embodiments, internal mapping circuit 110 may utilize SLAM techniques for this purpose. For example, internal mapping circuit 110 can utilize vehicle trace data from vehicle 100 and other vehicle(s) 180 to generate a SLAM representation (e.g., a geometric map) of an environment. Like external mapping system 140, internal mapping circuit 110 can also: (1) utilize (and train) a machine learning model to quantify accuracy of the SLAM representation based on values for intelligently curated features of the SLAM representation; (2) generate a digital representation of the quantified accuracy of the SLAM representation and/or (3) provide the digital representation on a GUI (e.g., a GUI of vehicle 100).

In various embodiments, either or both of external mapping system 140 and internal mapping circuit 110 may perform the above-described mapping and validation. In addition to mapping and validation, external mapping system 140 and internal mapping circuit 110 may also utilize data association techniques to identify/determine landmarks. Such data association techniques may also be used to fuse data obtained from different vehicles and different types of vehicle sensors. Such data association techniques may involve analyzing time stamps for sensor data, generating and analyzing covariance matrices which represent sensor uncertainty, and so on.

Referring now to vehicle 100 and FIG. 1A in more detail, as depicted, vehicle 100 comprises an internal mapping circuit 110, sensors 152, and vehicle systems 170. Sensors 152 and vehicle systems 170 can communicate with internal mapping circuit 110 via a wired or wireless communication interface. Although sensors 152 and vehicle systems 170 are depicted as communicating with internal mapping circuit 110, they can also communicate with each other. Internal mapping circuit 110 can be implemented as an electronic control unit (ECU) or as part of an ECU. In other embodiments, internal mapping circuit 110 can be implemented independently of an ECU.

In the specific example of FIG. 1A, internal mapping circuit 110 includes a communication circuit 101, a decision circuit 103 (including a processor 106 and a memory 108), and a power supply 112. Components of internal mapping circuit 110 are illustrated as communicating with each other via a data bus, although other interfaces can be included.

Processor 106 can include one or more general processing units (GPUs), central processing units (CPUs), microprocessors, or any other suitable processing system. Processor 106 may include a single core processor or multicore processors. Memory 108 may include one or more various forms of memory or data storage (e.g., flash, RAM, etc.) that may be used to store vehicle trace data (including matrices representing vehicle trace data), machine learning model parameters, calibration parameters, images (analysis or historic), point parameters, instructions and variables for processor 106 as well as any other suitable information. Memory 108, can be made up of one or more modules of one or more different types of memory, and may be configured to store data and other information as well as operational instructions that may be used by processor 106.

Although the example of FIG. 1A is illustrated using processor and memory circuitry, in various embodiments decision circuit 103 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up internal mapping circuit 110.

Communication circuit 101 can utilize a wireless transceiver circuit 102 with an associated antenna 105 for wireless communication. Communication circuit 101 can also utilize a wired I/O interface 104 with an associated hardwired data port (not illustrated). As this example illustrates, communications with internal mapping circuit 110 can include either or both wired and wireless communications. Wireless transceiver circuit 102 can include a transmitter and a receiver (not shown) to allow wireless communications via any of a number of communication protocols such as, for example,

WiFi, Bluetooth, near field communications (NFC), Zigbee, and any of a number of other wireless communication protocols whether standardized, proprietary, open, point-to-point, networked or otherwise. Antenna 105 is coupled to wireless transceiver circuit 102 and is used by wireless transceiver circuit 102 to transmit radio signals wirelessly to wireless equipment and to receive radio signals as well. These radio signals can include information of almost any sort that is sent or received by internal mapping circuit 110 to/from other entities such as sensors 152, vehicle systems 170, external mapping system 140, and other vehicle(s) 180.

Wired I/O interface 104 can include a transmitter and a receiver (not shown) for hardwired communications with other devices. For example, wired I/O interface 104 can provide a hardwired interface to other components, including sensors 152 and vehicle systems 170. Wired I/O interface 104 can communicate with other devices using Ethernet or any of a number of other wired communication protocols whether standardized, proprietary, open, point-to-point, networked or otherwise.

Power supply 112 can include one or more of a battery or batteries (such as, e.g., Li-ion, Li-Polymer, NiMH, NiCd, NiZn, and NiH2, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 152 can include, for example, vehicle acceleration sensors 113, vehicle speed sensors 114, wheelspin sensors 116 (e.g., one for each wheel), a tire pressure monitoring system (TPMS) 120, accelerometers such as a 3-axis accelerometer 122 to detect roll, pitch and yaw of the vehicle, vehicle clearance sensors 124, left-right and front-rear slip ratio sensors 126, environmental sensors 128 (e.g., to detect salinity or other environmental conditions), image sensor(s) 130, and location sensor(s) 132. Other sensors 135 can also be included as may be appropriate for a given implementation of vehicle 100. For example other sensors 135 may include gyroscopes, odometers, etc.

In some embodiments, image sensor(s) 130 may comprise one or more cameras configured to generate image data of an environment surrounding vehicle 100. The image data may comprise images of the environment.

In certain embodiments, location sensor(s) 132 may comprise a global navigation satellite sensor, a global position sensor, or other types of vehicle positioning sensors. Location sensor(s) 132 may be configured to generate location data for vehicle 100 and/or location data for landmarks in the environment surrounding vehicle 100. The location data may comprise precise coordinates (e.g., latitude, longitude, and altitude) of vehicle 100's position or the position(s) of landmark(s) on the Earth's surface.

In some embodiments, one or more of sensors 152 may include their own processing capability to compute the results for additional information that can be provided to internal mapping circuit 110. In other embodiments, one or more of sensors 152 may be data-gathering-only sensors that only provide raw data to internal mapping circuit 110. In further embodiments, one or more hybrid sensors may be included that provide a combination of raw data and processed data to internal mapping circuit 110. Sensors 152 may provide analog outputs, digital outputs, or a combination of both.

As alluded to above, in certain embodiments vehicle 100 may not include conventional sensors used to obtain “ground truth” trajectory data of vehicle 100 (e.g., RTK sensors) due to prohibitive expense.

Vehicle systems 170 can include any of a number of different vehicle components or subsystems used to control or monitor various aspects of vehicle 100 and its performance. For example, vehicle systems 170 may include any one or combination of a navigation system 172, an autonomous vehicle (AV) system 174, a semi-autonomous vehicle (SAV) system 176, and other vehicle systems 178.

In general, AV and SAV systems (e.g., AV system 174 and SAV system 176) can control driving behaviors of a vehicle. AV and SAV systems can interpret sensory information, identify appropriate traffic configurations, determine vehicle navigation paths, and actuate vehicle systems in accordance with determined vehicle navigation paths. Many AV and SAV systems are directed systems that minimize vehicle collisions.

As alluded to above, AV and SAV systems (e.g., AV system 174 and SAV system 176) can leverage a digital representation of a vehicle's environment to determine vehicle navigation paths. In general, improved accuracy of the digital representation can result in improved decision making for an AV/SAV system leveraging the digital representation. Accordingly, AV system 174 and SAV system 176 can leverage rapidly generated and accurate digital representations-provided by internal mapping circuit 110 and/or external mapping system 140—for improved autonomous/semi-autonomous driving performance. Relatedly, navigation system 172 can leverage such digital representations for improved navigation displays.

Referring now to external mapping system 140 and FIG. 1B in more detail, as depicted, external mapping system 140 may comprise a communication circuit 141, a decision circuit 143, and a power supply 147. Components of external mapping system 140 are illustrated as communicating with each other via a data bus, although other interfaces can be included.

Similar to decision circuit 101 of vehicle 100, decision circuit 143 may comprise a processor 146 and a memory 148. Processor 146 can include one or more general processing units (GPUs), central processing units (CPUs), microprocessors, or any other suitable processing system. Processor 146 may include a single core processor or multicore processors. Memory 148 may include one or more various forms of memory or data storage (e.g., flash, RAM, etc.) that may be used to store vehicle trace data (including matrices representing vehicle trace data), machine learning model parameters, calibration parameters, images (analysis or historic), point parameters, instructions and variables for processor 146 as well as any other suitable information. Memory 148, can be made up of one or more modules of one or more different types of memory, and may be configured to store data and other information as well as operational instructions that may be used by processor 146.

Although the example of FIG. 1B is illustrated using processor and memory circuitry, in various embodiments decision circuit 143 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up external mapping system 140.

Similar to communication circuit 101 of vehicle 100, communication circuit 141 can utilize a wireless transceiver circuit 142 with an associated antenna 145 for wireless communication. Communication circuit 141 can also utilize a wired I/O interface 144 with an associated hardwired data port (not illustrated). As this example illustrates, communications with external mapping system 140 can include either or both wired and wireless communications. Wireless transceiver circuit 142 can include a transmitter and a receiver (not shown) to allow wireless communications via any of a number of communication protocols such as, for example, Wifi, Bluetooth, near field communications (NFC), Zigbee, and any of a number of other wireless communication protocols whether standardized, proprietary, open, point-to-point, networked or otherwise. Antenna 145 is coupled to wireless transceiver circuit 142 and is used by wireless transceiver circuit 142 to transmit radio signals and to receive radio signals as well. These radio signals can include information of almost any sort that is sent or received by external mapping system 140 to/from other entities such as vehicle 100 and other vehicle(s) 180.

Wired I/O interface 184 can include a transmitter and a receiver (not shown) for hardwired communications with other devices. For example, wired I/O interface 184 can provide a hardwired interface to other components of external mapping system 140. Wired I/O interface 144 can communicate with other devices using Ethernet or any of a number of other wired communication protocols whether standardized, proprietary, open, point-to-point, networked or otherwise.

Power supply 142 can include one or more of a battery or batteries (such as, e.g., Li-ion, Li-Polymer, NiMH, NiCd, NiZn, and NiH2, to name a few, whether rechargeable or primary batteries,), a power connector, an energy harvester (e.g., solar cells, piezoelectric system, etc.), or it can include any other suitable power supply.

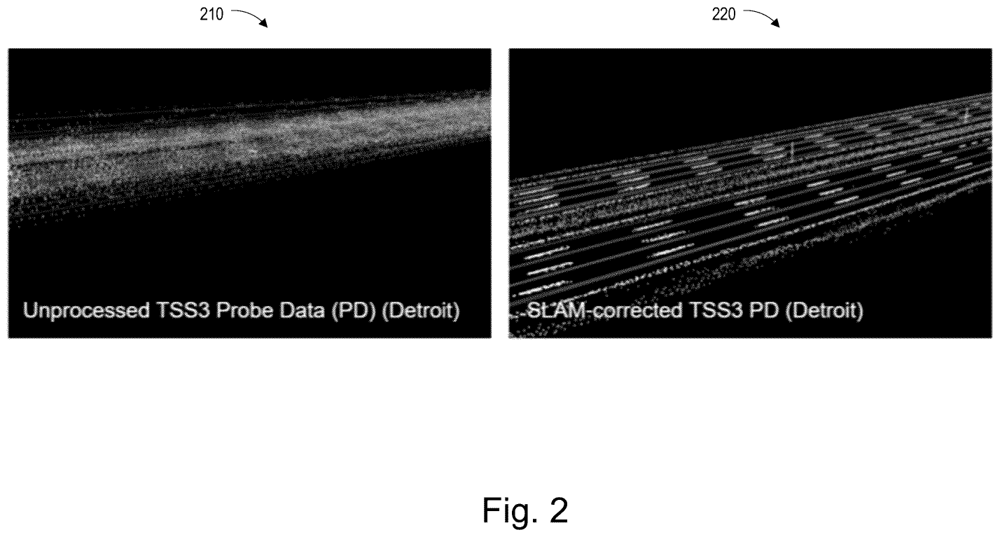

FIG. 2 illustrates a comparison between digital representations of an environment before and after SLAM optimization, in accordance with various embodiments of the presently disclosed technology.

Before describing FIG. 2 in detail, some background may be helpful.

As described above, vehicle sensors (e.g., imaging and proximity sensors, gyroscopes, odometers, etc.) can collect information about a vehicle (e.g., vehicle 100 from FIGS. 1A-1B) and the vehicle's surroundings. Such data can be used to generate a digital representation (e.g., a geometric map) of an environment surrounding the vehicle. For example, a system may mount an imaging device (e.g., a camera) to a vehicle in motion within an environment. The system can use image data generated by the imaging device to generate a digital representation of the environment.

Simultaneous Localization and Mapping (“SLAM”) is one technique for generating such a digital representation. A SLAM system can generate a digital representation of an environment while simultaneously tracking location of a vehicle within that environment.

Vehicle trace data is a type of data utilized by SLAM systems (and other similar systems) to generate a digital representation of an environment. As used herein, vehicle trace data may refer to any combination of: (1) data related to a three-dimensional (3D) trajectory of a vehicle as the vehicle traverses an environment; and (2) data related to landmarks observed by vehicle sensors as the vehicle traverses the environment. In some implementations (e.g., when mapping a large geographic area), a SLAM system will utilize vehicle trace data obtained from many consumer vehicles (e.g., hundreds or thousands of consumer vehicles) to map an environment. Utilizing vehicle trace data from many vehicles can be helpful for generating a more complete digital representation of a large environment. However, such vehicle trace data-along with digital representation generated from such vehicle trace data-can be “fuzzy” due to discrepancies in observations among vehicles.

To reduce “fuzziness” in vehicle trace data (and to improve crispness of a digital representation generated from the vehicle trace data), a SLAM system typically applies an optimization algorithm to the vehicle trace data.

Referring now to FIG. 2, representation 210 depicts a digital representation of an environment-in this specific example, a multi-lane highway-based on vehicle trace data before the vehicle trace data has been optimized by a SLAM system. The vehicle trace data in this example was obtained from many vehicles/many vehicle sensors. For this reason, representation 210 (which depicts the digital representation of the multi-lane highway generated from the vehicle trace data) appears “fuzzy” due to discrepancies in observations among the many vehicles/many vehicle sensors.

Representation 220 depicts a SLAM representation of the multi-lane highway based on an optimized version of the vehicle trace data (i.e., after a SLAM algorithm, or similar optimization algorithm, has been applied to the vehicle trace data).

As can been seen in FIG. 2, representation 220 depicts the multi-lane highway segment more crisply than representation 210. Again, this is due to SLAM optimization.

However, even with the above-described optimization, a SLAM representation (e.g., the SLAM representation depicted by representation 220) may include defective areas where the SLAM representation does not accurately map an environment. Such inaccuracies can cause safety and other issues with operation of a vehicle that relies on the SLAM representation for navigation and other tasks (e.g., autonomous driving). Accordingly, there is an important need for systems/methods that reliably validate accuracy for SLAM representations.

As described above, aspects of the presently disclosed technology may be implemented to validate accuracy of a SLAM representation in the absence of “ground truth” vehicle trajectory data. Namely, a system of the presently disclosed technology (e.g., external mapping system 140) may utilize (and train) a machine learning model to quantify accuracy of a SLAM representation based on values for intelligently curated features of the SLAM representation. The system may then generate a digital representation for the quantified accuracy of the SLAM representation. In various embodiments, the digital representation may comprise a heat map superimposed on the SLAM representation. In certain embodiments, the system may provide the digital representation via a graphical user interface (GUI).

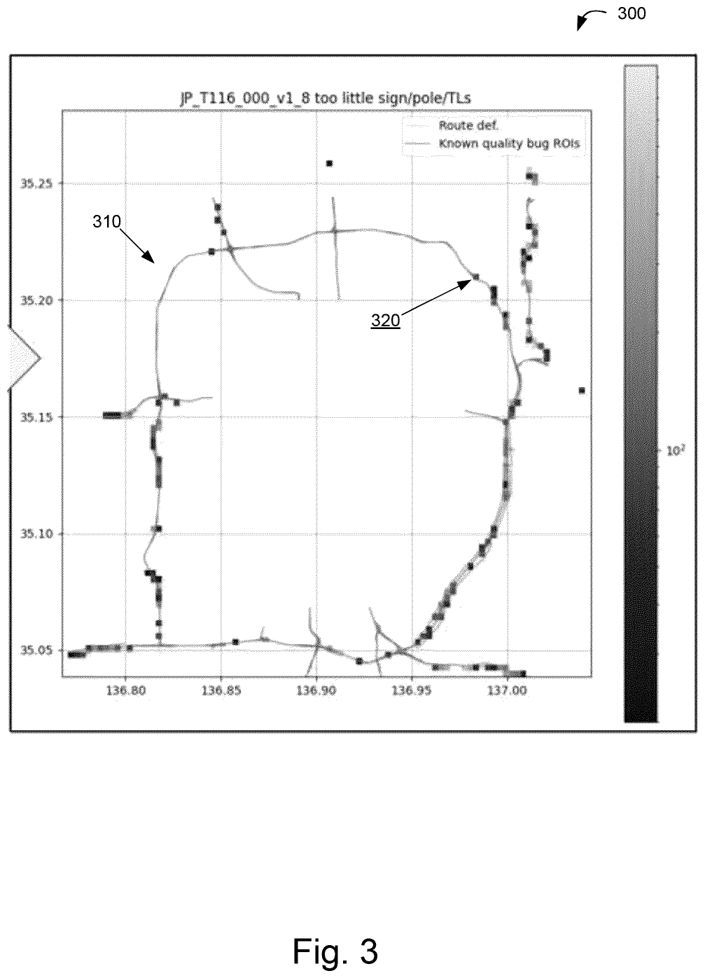

FIG. 3 illustrates an example of such a digital representation. Namely, representation 300 of FIG. 3 illustrates a heat map superimposed on a SLAM representation 310.

As depicted, SLAM representation 310 maps/represents a highway-loop of a road network. A respective square of representation 300 (e.g., square 320) quantifies accuracy (i.e., via color-coding) for the region of SLAM representation 300 over which the respective square is superimposed. It should be understood that in other implementations other shapes besides squares (e.g., hexagons) may be used to visual accuracy for regions of SLAM representation 310.

While the specific example of FIG. 3 illustrates a heat map superimposed on SLAM representation 310, it should be understood that in other embodiments the digital representation quantifying accuracy of SLAM representation 310 may take other forms.

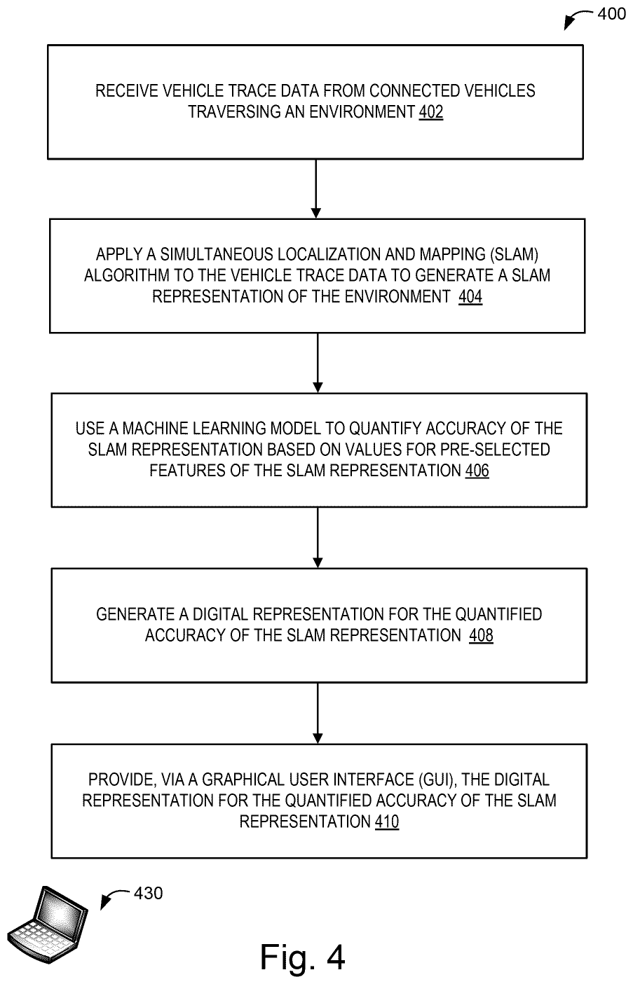

FIG. 4 illustrates an example process 400 that can be performed by a system 430 to validate SLAM representation accuracy, in accordance with various embodiments of the presently disclosed technology. In various embodiments, system 430 may comprise external mapping system 140 from FIGS. 1A-1B.

As depicted, system 430 may perform operation 402 to receive vehicle trace data from connected vehicles traversing an environment.

In certain implementations, the connected vehicles may comprise consumer vehicles (e.g., hundred or thousands of consumer vehicles).

As described above, the vehicle trace data may comprise any combination of: (1) data related to three-dimensional (3D) trajectories of the connected vehicles as the connected vehicles traverse the environment; and (2) data related to landmarks observed by sensors of the connected vehicles as the connected vehicles traverse the environment.

As depicted, system 430 may perform operation 404 to apply a SLAM algorithm (or similar optimization algorithm) to the vehicle trace data to generate a SLAM representation (e.g., a geometric map). In certain implementations, the vehicle trace data may be represented via a matrix (or matrices) and applying the SLAM algorithm to the vehicle trace data may comprise performing matrix operations.

In certain examples the system may utilize a geospatial grid (e.g., a geospatial grid of hexagonal tiles) to generate the SLAM representation. Here, a respective tile of the geospatial grid may correspond to a contiguous geographic/geospatial region of the Earth. Geospatial grids are sometimes referred to as discrete global grid systems. The H3 geospatial indexing system is one illustrative example of a discrete global grid system.

In certain embodiments where system 430 uses a geospatial grid to generate the SLAM representation, the geospatial grid may comprise a multi-precision hexagonal tiling of a sphere (corresponding to the Earth/globe) with hierarchical indexes. The geospatial grid may be created on the planar faces of a sphere-circumscribed icosahedron (corresponding to the Earth/globe), and individual hexagonal tiles may be projected to the surface of the sphere-circumscribed icosahedron. The projection may implement various processes, including an inverse face-centered polyhedral gnomonic projection. The geospatial grid may also include a coordinate reference system (CRS). The CRS may correspond with spherical coordinates of the WGS84/EPSG: 4326 authalic radius. In some embodiments, the geospatial grid may be constructed on the sphere-circumscribed icosahedron by recursively creating increasingly higher precision hexagonal tiles until a predetermined resolution is achieved.

As depicted, system 430 can perform operation 406 to use a machine learning model to quantify accuracy of the SLAM representation based on values for pre-selected features of the SLAM representation.

As described above, by using a machine learning model to quantify accuracy of the SLAM representation based on intelligently curated features of the SLAM representation (i.e., the pre-selected features), system 430 can validate accuracy of the SLAM representation in the absence of “ground truth” trajectory data for the connected vehicles. Here, the intelligently curated features of the SLAM representation may be important, indirect indicators of SLAM representation accuracy.

Distance between landmarks in the SLAM representation is one example SLAM representation feature that system 430 can use to quantify/predict SLAM representation accuracy. As system 430 is designed in appreciation of, accuracy/crispness of the SLAM representation may increase when a relatively higher proportion of the vehicle trace data used to generate the SLAM representation comprises perceptual data vs. proprioception data. Distance between landmarks in the SLAM representation can indirectly measure this proportion between perceptual data vs. proprioception data. Namely, the farther a respective connected vehicle has to travel between perceiving two landmarks, the more the respective connected vehicle will rely on proprioception (e.g., dead-reckoning) techniques to infer its location/trajectory. In other words, the farther the respective connected vehicle has to travel between perceiving two landmarks, the less the respective connected vehicle can rely on perceptual techniques to infer its location/trajectory. In this way, distance between landmarks in the SLAM representation can indirectly measure the proportion between perceptual data vs. proprioception data in the vehicle trace data used to generate the SLAM representation. For these reasons, training the machine learning model to quantify accuracy for SLAM representations based in part on distances between landmarks in the SLAM representations, can provide an improved methodology for validating SLAM representation accuracy

Node degree for landmarks in a SLAM representation is another example SLAM representation feature that the system can use to quantify/predict SLAM representation accuracy. As used herein, a node degree for a respective landmark may correspond to a number of observations from different viewpoints a SLAM representation correlates with the respective landmark. As system 430 is designed in appreciation of, node degree can be a useful (indirect) measure of data association confidence for the SLAM representation. Namely, increasing node degree can correlate with increasing data association confidence for the SLAM representation. Relatedly, increasing data association confidence for landmarks in the SLAM representation may correlate with increasing accuracy for the SLAM representation. For these reasons, training the machine learning model to quantify accuracy for SLAM representations based in part on node degree for landmarks in the SLAM representations, can provide an improved methodology for validating SLAM representation accuracy.

In addition to (or in lieu of) distance between landmarks and node degree, system 430 may utilize other intelligently curated features of the SLAM representation to quantify accuracy for the SLAM representation. For example, system 430 may train the machine learning model to quantify accuracy for the SLAM representation based on hundreds of SLAM representation features or more.

The machine learning model itself may comprise various types of machine learning models, including for example, a random forest model.

The machine learning model may use various types of metrics or methodologies to quantify accuracy of the SLAM representation. For example, the machine learning model may use a five-fold cross-validation methodology capable of producing various metrics. Such metrics may include, e.g., area-under-the-receiver operating characteristic (ROC)-curve, precision, accuracy, f1, true-positive-rate, false-positive-rate, recall, and so on.

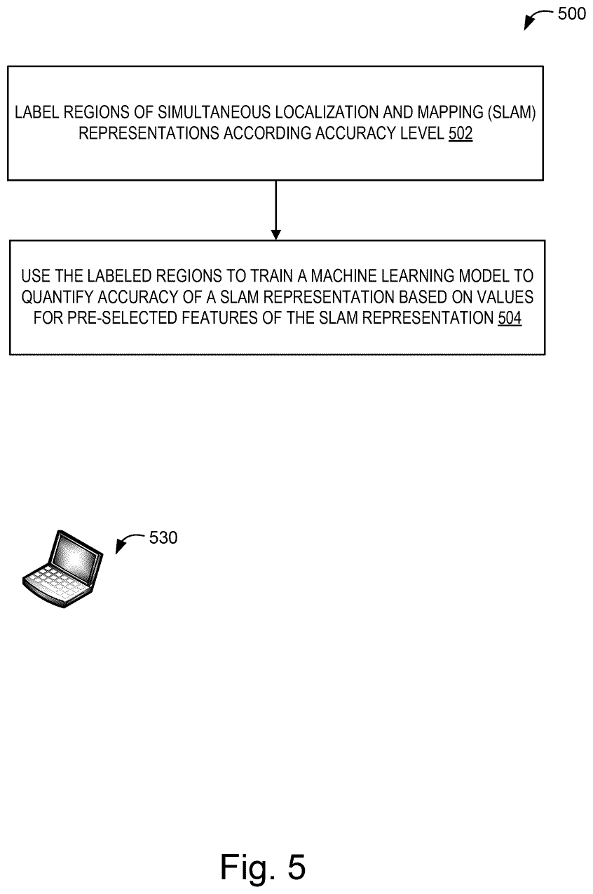

In certain embodiments (e.g., where system 430 uses a geospatial grid of tiles to generate the SLAM representation), the machine learning model may compute an accuracy score (or similar metric, such as a binary metric) for respective tiles of the SLAM representation. As described in greater detail in conjunction with FIG. 5, the machine learning model may be trained to quantify accuracy of the SLAM representation using tiles which are labeled according to accuracy scores (or similar metrics, such as a binary metric).

As depicted, system 430 can perform operation 408 to generate a digital representation for the quantified accuracy of the SLAM representation. In certain embodiments, the digital representation for the quantified accuracy of the SLAM representation may comprise a heat map superimposed on the SLAM representation (see e.g., FIG. 3 for an illustrative example).

As depicted, system 430 can perform operation 410 to provide, via a graphical user interface (GUI), the digital representation for the quantified accuracy of the SLAM representation. In certain embodiments, the GUI may be implemented as part of system 430, or on a remotely located user device.

FIG. 5 illustrates an example process 500 that can be performed by a system 530 to train a machine learning model to validate SLAM representation accuracy, in accordance with various embodiments of the presently disclosed technology. In various embodiments, system 530 may comprise external mapping system 140 of FIGS. 1A-1B.

As depicted, system 530 may perform operation 502 to label regions of SLAM representations according to accuracy level (e.g., using a metric that quantifies accuracy for a respective region). In embodiments where a geospatial grid of tiles is used to generate a SLAM representation, each respective tile of a SLAM representation may be labeled according to accuracy level. Various metrics may be used to label the regions according to accuracy level. For example, system 530 may use a five-fold cross-validation methodology capable of producing various metrics. Such metrics may include, e.g., area-under-the-receiver operating characteristic (ROC)-curve, precision, accuracy, f1, true-positive-rate, false-positive-rate, recall, and so on.

In some embodiments, system 530 may perform operation 502 in response to user input(s).

As depicted, system 530 can perform operation 504 to use the labeled regions to train a machine learning model to quantify accuracy of a SLAM representation based on values for pre-selected features of the SLAM representation.

As described above, two illustrative examples of the pre-selected features may comprise: (1) distance between landmarks in the SLAM representation; and (2) node degrees for the landmarks in the SLAM representation. However, other pre-selected features may be used in addition to (or in lieu of) these two illustrative examples.

The machine learning model itself may comprise various types of machine learning models, including for example, a random forest model.

The machine learning model may use various types of metrics to quantify accuracy of the SLAM representation. For example, the machine learning model may use a five-fold cross-validation methodology capable of producing various metrics. Such metrics may include, e.g., area-under-the-receiver operating characteristic (ROC)-curve, precision, accuracy, f1, true-positive-rate, false-positive-rate, recall, and so on.

In certain embodiments (e.g., where a geospatial grid of tiles is used to generate the SLAM representation), the machine learning model may be trained to compute an accuracy score (or similar metric, such as a binary metric) for respective tiles of the SLAM representation.

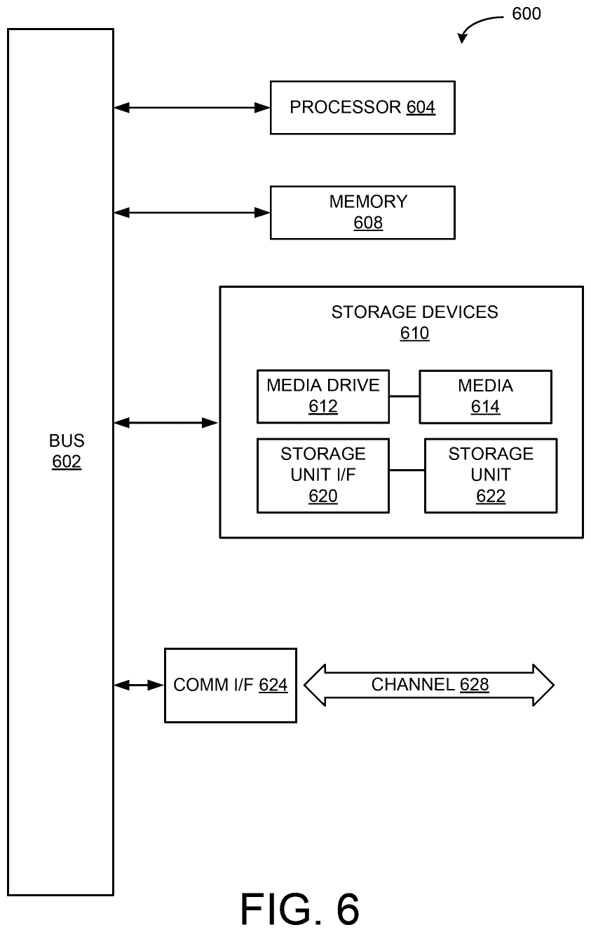

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 6. Various embodiments are described in terms of this example-computing component 600. After reading this description, it will become apparent to a person skilled in the relevant art how to implement the application using other computing components or architectures.

Referring now to FIG. 6, computing component 600 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 600 might also represent computing capabilities embedded within or otherwise available to a given device. For example, a computing component might be found in other electronic devices such as, for example, portable computing devices, and other electronic devices that might include some form of processing capability.

Computing component 600 might include, for example, one or more processors, controllers, control components, or other processing devices. This can include a processor, and/or any one or more of the components making up a user device, a user system, and a non-decrypting cloud service. Processor 604 might be implemented using a general-purpose or special-purpose processing engine such as, for example, a microprocessor, controller, or other control logic. Processor 604 may be connected to a bus 602. However, any communication medium can be used to facilitate interaction with other components of computing component 600 or to communicate externally.

Computing component 600 might also include one or more memory components, simply referred to herein as main memory 608. For example, random access memory (RAM) or other dynamic memory, might be used for storing information and instructions to be executed by processor 604. Main memory 608 might also be used for storing temporary variables or other intermediate information during execution of instructions to be executed by processor 604. Computing component 600 might likewise include a read only memory (“ROM”) or other static storage device coupled to bus 602 for storing static information and instructions for processor 604.

The computing component 600 might also include one or more various forms of information storage mechanism 610, which might include, for example, a media drive 612 and a storage unit interface 620. The media drive 612 might include a drive or other mechanism to support fixed or removable storage media 614. For example, a hard disk drive, a solid-state drive, a magnetic tape drive, an optical drive, a compact disc (CD) or digital video disc (DVD) drive (R or RW), or other removable or fixed media drive might be provided. Storage media 614 might include, for example, a hard disk, an integrated circuit assembly, magnetic tape, cartridge, optical disk, a CD or DVD. Storage media 614 may be any other fixed or removable medium that is read by, written to or accessed by media drive 612. As these examples illustrate, the storage media 614 can include a computer usable storage medium having stored therein computer software or data.

In alternative embodiments, information storage mechanism 610 might include other similar instrumentalities for allowing computer programs or other instructions or data to be loaded into computing component 600. Such instrumentalities might include, for example, a fixed or removable storage unit 622 and interface 620. Examples of such storage units 622 and interfaces 620 can include a program cartridge and cartridge interface, a removable memory (for example, a flash memory or other removable memory component) and memory slot. Other examples may include a PCMCIA slot and card, and other fixed or removable storage units 622 and interfaces 620 that allow software and data to be transferred from storage unit 622 to computing component 600.

Computing component 600 might also include a communications interface 624. Communications interface 624 might be used to allow software and data to be transferred between computing component 600 and external devices. Examples of communications interface 624 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 624 may be carried on signals, which can be electronic, electromagnetic (which includes optical) or other signals capable of being exchanged by a given communications interface 624. These signals might be provided to communications interface 624 via a channel 628. Channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 608, storage unit 620, media 614, and channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 600 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system comprising:
one or more processing resources;
non-transitory computer-readable medium, coupled to the one or more processing resources, comprising stored instructions that when executed by the one or more processing resources, cause the system to:
generate a Simultaneous Localization and Mapping (SLAM) representation of an environment;
use a machine learning model to quantify accuracy of the SLAM representation based on values for pre-selected features of the SLAM representation; and
generate a digital representation for the quantified accuracy of the SLAM representation.

2. The system of claim 1, wherein the pre-selected features of the SLAM representation comprise at least one of:
distance between two or more landmarks in the SLAM representation; or
node degrees for landmarks in the SLAM representation.

3. The system of claim 1, wherein a node degree for a respective landmark in the SLAM representation corresponds to a number of observations from different viewpoints the SLAM representation correlates with the respective landmark.

4. The system of claim 1, wherein the SLAM representation comprises a geometric map.

5. The system of claim 1, wherein the digital representation for the quantified accuracy of the SLAM representation comprises a heat map superimposed on the SLAM representation.

6. The system of claim 1, wherein the machine learning model comprises a random forest model.

7. The system of claim 1, wherein the machine learning model uses a five-fold cross-validation method to quantify accuracy for individual regions of the SLAM representation.

8. The system of claim 1, wherein the non-transitory computer-readable medium comprises further stored instructions, that when executed by the one or more processing resources, cause the system to:
provide, via a graphical user interface (GUI), the digital representation for the quantified accuracy of the SLAM representation.

9. The system of claim 1, wherein the non-transitory computer-readable medium comprises further stored instructions, that when executed by the one or more processing resources, cause the system to:
receive vehicle trace data from connected vehicles traversing the environment; and
apply a SLAM algorithm to the vehicle trace data to generate the SLAM representation.

10. The system of claim 9, wherein the vehicle trace data comprises at least one of:
data related to three-dimensional (3D) trajectories of the connected vehicles as the connected vehicles traverse the environment; or
data related to landmarks observed by sensors of the connected vehicles as the connected vehicles traverse the environment.

11. A method comprising:
receiving vehicle trace data from connected vehicles traversing an environment;
applying a Simultaneous Localization and Mapping (SLAM) algorithm to the vehicle trace data to generate a SLAM representation of the environment;
using a machine learning model to quantify accuracy of the SLAM representation based on values for pre-selected features of the SLAM representation;
generating a digital representation for the quantified accuracy of the SLAM representation; and
providing, via a graphical user interface (GUI) of a user device, the digital representation for the quantified accuracy of the SLAM representation.

12. The method of claim 11, wherein the pre-selected features of the SLAM representation comprise:
distance between landmarks in the SLAM representation; and
node degrees for the landmarks in the SLAM representation.

13. The method of claim 12, wherein a node degree for a respective landmark in the SLAM representation corresponds to a number of observations from different viewpoints the SLAM representation correlates with the respective landmark.

14. The method of claim 11, wherein the SLAM representation comprises a geometric map.

15. The method of claim 11, wherein the digital representation for the quantified accuracy of the SLAM representation comprises a heat map superimposed on the SLAM representation.

16. The method of claim 11, wherein the machine learning model comprises a random forest model.

17. The method of claim 11, wherein the machine learning model uses a five-fold cross-validation method to quantify accuracy for individual regions of the SLAM representation.

18. The method of claim 17, wherein the vehicle trace data comprises at least one of:
data related to three-dimensional (3D) trajectories of the connected vehicles as the connected vehicles traverse the environment; or
data related to landmarks observed by sensors of the connected vehicles as the connected vehicles traverse the environment.

19. A system comprising:
a graphical user interface (GUI);
one or more processing resources coupled to the GUI; and
non-transitory computer-readable medium, coupled to the one or more processing resources, comprising stored instructions that when executed by the one or more processing resources, cause the system to:
receive vehicle trace data from connected vehicles traversing an environment;
apply a Simultaneous Localization and Mapping (SLAM) algorithm to the vehicle trace data to generate a SLAM representation of the environment;
use a machine learning model to quantify accuracy of the SLAM representation based on values for pre-selected features of the SLAM representation;
generate a digital representation for the quantified accuracy of the SLAM representation; and
provide, via the GUI, the digital representation for the quantified accuracy of the SLAM representation.

20. The system of claim 19, wherein:
the SLAM representation comprises a geometric map; and
the digital representation for the quantified accuracy of the SLAM representation comprises a heat map superimposed on the geometric map.
